(19) United States
(12) Patent Application Publication
(10) Pub. No.: US 2026/0180754 A1
(43) Pub. Date: Jun. 25, 2026

(54) SIMULTANEOUS OR CONTEMPORANEOUS SPATIAL DOMAIN MULTIPLEXED PHYSICAL UPLINK SHARED CHANNEL TRANSMISSION USING A SINGLE DOWNLINK CONTROL INFORMATION AND TWO SOUNDING REFERENCE SIGNAL RESOURCE SETS

(71) Applicant: Apple Inc., Cupertino, CA (US)

(72) Inventors: Haitong Sun, Cupertino, CA (US); Hong He, San Jose, CA (US); Wei Zeng, Saratoga, CA (US); Chunxuan Ye, San Diego, CA (US); Chunhai Yao, Beijing (CN); Dawei Zhang, Saratoga, CA (US); Jie Cui, San Jose, CA (US); Seyed Ali Akbar Fakoorian, San Diego, CA (US)

(21) Appl. No.: 19/126,627

(22) PCT Filed: Nov. 2, 2022
(86) PCT No.: PCT/CN2022/129308

§ 371 Date: May 1, 2025

(51) Int. Cl. H04L 5/00; H04W 72/21; H04W 72/232

(52) U.S. Cl. CPC H04L 5/0051; H04W 72/21; H04W 72/232

(57) ABSTRACT

A user equipment (UE) includes a transceiver associated with a first antenna panel and a second antenna panel of at least two antenna panels, and a processor configured to receive a single downlink control information (DCI) for simultaneous or contemporaneous code-book based physical uplink shared channel (PUSCH) transmission with spatial domain multiplexing (SDM). The processor is configured to receive a configuration of a first SRS-ResourceSet and a second SRS-ResourceSet of at least two sounding reference signal resource sets (SRS-ResourceSets). The first SRS-ResourceSet is mapped to the first antenna panel and the second SRS-ResourceSet is mapped to the second antenna panel. The processor is configured to transmit, simultaneously or contemporaneously, a first sounding reference signal (SRS) using the first SRS-ResourceSet and the first antenna panel, and a second SRS using the second SRS-ResourceSet and the second antenna panel for simultaneous or contemporaneous codebook based PUSCH transmission with SDM.

### TECHNICAL FIELD

This application relates generally to wireless communication systems, including methods and systems for simultaneous or contemporaneous physical uplink shared channel (PUSCH) transmission using spatial domain multiplexing (SDM).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows an example of physical uplink shared channel (PUSCH) transmission using spatial domain multiplexing (SDM), according to embodiments described herein.

FIG. 3 shows an example mapping of two SRS resource indicator fields in a downlink control information (DCI) to SRS-Resources of an SRS-ResourceSet of a plurality of SRS-ResourceSets, and an antenna panel of a plurality of antenna panels, according to embodiments described herein.

FIG. 4 shows another example mapping of a single SRS resource indicator field in a downlink control information (DCI) to SRS-Resources of an SRS-ResourceSet of a plurality of SRS-ResourceSets, and an antenna panel of a plurality of antenna panels, according to embodiments described herein.

FIG. 5 shows an example mapping of a transmit precoding matrix indicator (TPMI) and a plurality of sounding reference signal (SRS) ports of a plurality of SRS-ResourceSets, according to embodiments described herein.

FIG. 6 shows an example method of wireless communication by a UE, which method may be used for codebook based simultaneous or contemporaneous PUSCH transmission with SDM, according to embodiments described herein.

FIG. 7 shows an example method of wireless communication by a UE, which method may be used for noncodebook based simultaneous or contemporaneous PUSCH transmission with SDM, according to embodiments described herein.

FIG. 8 shows an example method of wireless communication by a network device, which method may be used to configure a UE for codebook based or noncodebook based simultaneous or contemporaneous PUSCH transmission with SDM, according to embodiments described herein.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments described in the present disclosure correspond with a simultaneous or contemporaneous physical uplink shared channel (PUSCH) transmission using spatial domain multiplexing (SDM). The simultaneous or contemporaneous PUSCH transmission with SDM is scheduled using a single downlink control information (DCI). Further, the PUSCH transmission with SDM may be a codebook based and/or a noncodebook based PUSCH transmission. In some embodiments, a single DCI based simultaneous or contemporaneous PUSCH transmission with SDM may be made using two sounding reference signal resource sets (SRS-ResourceSets) for the codebook based or the noncodebook based PUSCH transmission.

In 5G or 5G New Radio (5G NR), uplink (UL) or PUSCH transmissions using multi-input multi-output (MIMO) antenna panels may be made according to one or both of the two MIMO operation modes—codebook based, and noncodebook based—and may support up to four layers. For codebook based transmissions of PUSCH (or UL), SRS-ResourceSet usage may be set to “codebook,” and a UE may accordingly transmit the SRS resource with a plurality of ports, and a network device of a network (e.g., a RAN and/or a CN) may configure a UE for a particular transmit precoding matrix indicator (TPMI) and rank indicator (RI) for the PUSCH transmission. Similarly, for the noncodebook based transmission of PUSCH (or UL), SRS-ResourceSet usage may be set to “nonCodebook,” and a UE may according transmit a plurality of SRS resources using a single port, and the network device may configure a UE for a particular TPMI and RI for the PUSCH transmission via selection of one or more transmitted SRS-Resources. Further, various embodiments for the codebook based PUSCH transmission, as described in the present disclosure, may correspond with a coherent mode, a partial-coherent mode, and/or a non-coherent mode, depending on a UE capability.

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

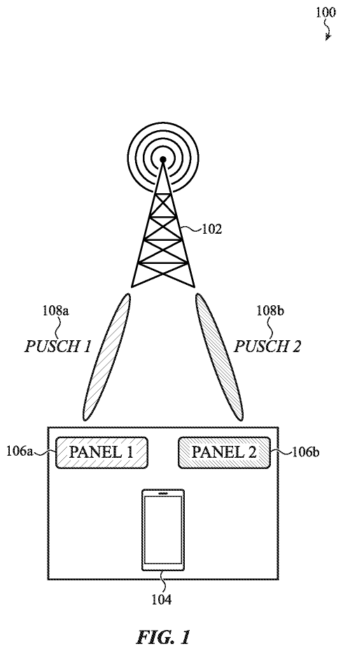

FIG. 1 shows an example wireless communication system, according to embodiments described herein. As shown in FIG. 1, a wireless communication system 100 may include a network device 102 and a user equipment (UE) 104. The UE 104 may be communicatively coupled with the network device 102, to transmit data in an uplink (UL) direction. For example, the UE 104 may make a PUSCH transmission, shown as PUSCH 1 108a and PUSCH 2 108b, via a first antenna panel 106a and a second antenna panel 106b of the UE 104. The UE 104 may also receive data in a downlink (DL) direction using the first antenna panel 106a and the second antenna panel 106b.

In some embodiments, the network device 102 may be an eNodeB (eNB), a gNodeB (gNB), or an access point (AP) in a RAN and may support one or more radio access technologies, such as 4G, 5G new radio (5G NR, or 5G), 6G, and so on. The UE 104 may be a phone, a smart phone, a tablet, a smartwatch, an Internet-of-Things (IoT), a vehicle, and so on. A reference to a user equipment (UE) in the present disclosure is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

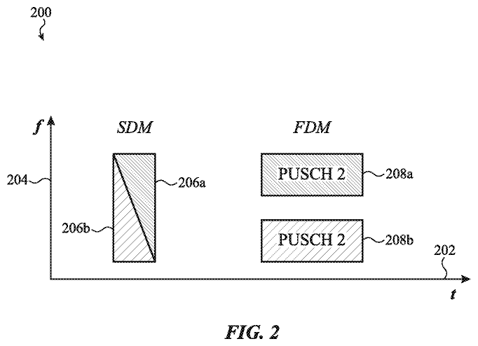

FIG. 2 shows an example of physical uplink shared channel (PUSCH) communication using spatial domain multiplexing (SDM), according to embodiments described herein. As shown in a graph 200, simultaneous or contemporaneous PUSCH (or UL) transmission using multiple antenna panels 206a and 206b of a UE 204 may be performed either using frequency division multiplexing (FDM) or SDM. In FDM, PUSCH 1 208a and PUSCH 2 208b each may correspond with a different frequency range or a different frequency band, which is shown in the graph 200 along a Y axis representing a frequency range. The PUSCH 1 208a and the PUSCH 2 208b may occur simultaneously or contemporaneously as shown in the diagram along a X axis representing time. In SDM, PUSCH 1 206a and PUSCH 2 206b may use the same frequency range or frequency band over the same time period, in other words, simultaneously or contemporaneously. In SDM, simultaneous or contemporaneous PUSCH transmission using the same frequency band may be achieved using a beam forming technique to avoid interference during PUSCH transmission to a network device.

In the present disclosure, details of various embodiments describe supporting PUSCH (or UL) transmission with SDM and at least two antenna panels of a UE. However, for embodiments in the present disclosure, a UE with two antenna panels is assumed. Each of the two antenna panels of the UE may have a corresponding sounding reference signal resource set (SRS-ResourceSet). Accordingly, two SRS-ResourceSets may be used corresponding to each antenna panel of two antenna panels of the UE. The PUSCH (or UL) transmission with SDM may be codebook based and/or noncodebook based, and scheduled using a single DCI. A network device may transmit to a UE a configuration associated with, or corresponding to, two SRS-ResourceSets. The configuration associated with, or corresponding to, two SRS-ResourceSets may set usage of a SRS-ResourceSet to “codebook” for codebook based PUSCH (or UL) transmission or “nonCodebook” for noncodebook based PUSCH (or UL) transmission.

In some embodiments, and by way of a non-limiting example, for codebook based and/or noncodebook based PUSCH (or UL) transmission, each SRS-ResourceSet may correspond with an antenna panel and, accordingly, a first SRS-ResourceSet may map to a first antennal panel of two antenna panels of the UE, and a second SRS-ResourceSet may map to a second antennal panel of the two antenna panels of the UE. Alternatively, a first SRS-ResourceSet may map to a second antenna panel of two antenna panels of the UE, and a second SRS-ResourceSet may map to a first antenna panel of the two antennal panels of the UE.

In some embodiments, and by way of a non-limiting example, for codebook based and/or noncodebook based PUSCH (or UL) transmission, each SRS-ResourceSet may be configured, by a network (e.g., a network device in a RAN or a CN), with the same number of SRS resources. In some embodiments, a first SRS-ResourceSet may have a different number of SRS resources than a second SRS-ResourceSet. A UE may be configured by the network, in some embodiments, with an uplink full power mode of 0 or 1. Alternatively, a UE may not be configured for an uplink full power. By way of a non-limiting example, when the UE is not configured with an uplink full power mode of 2, an SRS-Resource in both the first SRS-ResourceSet and the second SRS-ResourceSet may be configured, by the network, with the same number of SRS ports. Alternatively, or additionally, an SRS-Resource in both the first SRS-ResourceSet and the second SRS-ResourceSet may be configured, by the network, with a different number of SRS ports without regards to the uplink full power mode of the UE.

In some embodiments, a dynamic point selection (DPS) for codebook based or noncodebook based simultaneous or contemporaneous PUSCH (or UL) transmission with SDM, which is configured using a single DCI, may be supported by using a SRS resource set indication field of the DCI. The SRS resource set indication field, by way of a non-limiting example, may be of a plurality bits. For example the SRS resource set indication field may be of two bits. Accordingly, possible values of the SRS resource set indication field may be 00, 01, 10, and 11.

In some embodiments, a value of the SRS resource set indication field in the DCI may be set to 00 to configure or instruct the UE to use a first antenna panel of two antenna panels using a first SRS-ResourceSet for the codebook based simultaneous or contemporaneous PUSCH transmission, as described herein. A value of the SRS resource set indication field in the DCI may be set to 01 to configure or instruct the UE to use a second antenna panel of two antenna panels using a second SRS-ResourceSet for the codebook based simultaneous or contemporaneous PUSCH transmission, as described herein. In other words, when a most significant bit (MSB) of the SRS resource set indication field is set to 0, a value of a least significant bit (LSB) of the SRS resource set indication field may describe, or instruct the UE, to use a first antenna panel (using a first SRS-ResourceSet) when the LSB is set to 0, and to use a second antenna panel (using a second SRS-ResourceSet) when the LSB is set to 1.

A value of the SRS resource set indication field in the DCI may be set to 10 to configure or instruct the UE to use a first antenna panel of two antenna panels using a first SRS-ResourceSet, and a second antenna panel of two antenna panels using a second SRS-ResourceSet, for the codebook based simultaneous or contemporaneous PUSCH transmission, as described herein. In other words, when a MSB of the SRS resource set indication field is set to 1, a value of a LSB of the SRS resource set indication field is set to 0, the UE may use both of the first and the second antenna panels and the corresponding first and second SRS-ResourceSets.

When a value of the SRS resource set indication field in the DCI is set to 11, in some embodiments, the UE may consider this value as being reserved, and may ignore it. In other words, the value 11 for the SRS resource set indication field may be treated by the UE to map and transmit the codebook based PUSCH (or UL) transmission with SDM, as described herein, using one or more antenna panels and corresponding one or more SRS-ResourceSets. The UE may determine one or more antenna panels based on various factors, including QoS of data, and so on. Alternatively, the value of 11 for the SRS resource set indication may be used to toggle a mapping of an antenna panel of the at least two antenna panels and a respective SRS-ResourceSet of the at least two SRS-ResourceSets. For example, in one case, a first SRS resource indication field may map to a first SRS-ResourceSet, and a second SRS resource indication field may map to a second SRS-ResourceSet; in another case, a first SRS resource indication field may map to a second SRS-ResourceSet, and a second SRS resource indication field may map to a first SRS-ResourceSet. Additionally, or alternatively, in one case, a first SRS-ResourceSet may map to a first antenna panel and a second SRS-ResourceSet may map to a second antenna panel; in another, a first SRS-ResourceSet may map to a second antenna panel and a second SRS-ResourceSet may map to a first antenna panel.

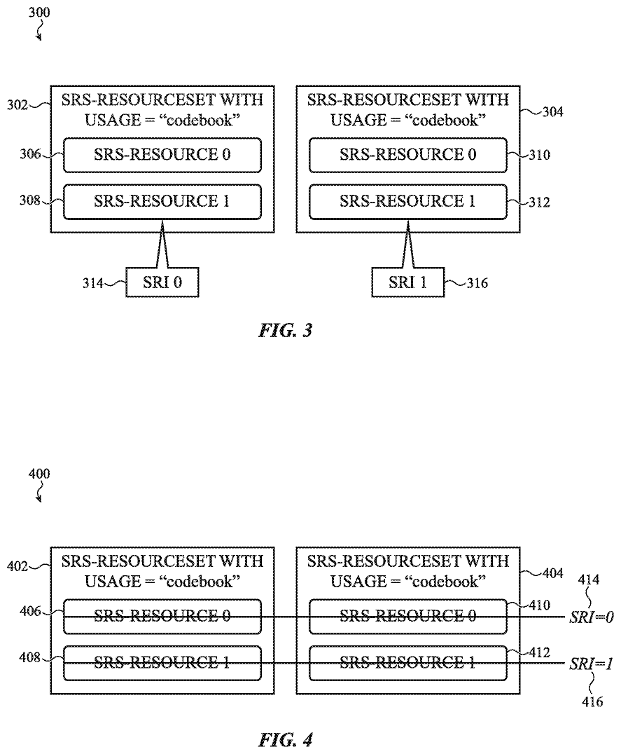

FIG. 3 shows an example mapping of two SRS resource indicator fields in a downlink control information (DCI) to SRS-Resources of an SRS-ResourceSet of a plurality of SRS-ResourceSets and an antenna panel of a plurality of antenna panels, according to embodiments described herein. As described herein, a single DCI field may include two SRS resource indicator (SRI) fields such that a first SRI field corresponds to a first SRS-ResourceSet, which corresponds with a first antenna panel of two antenna panels, and a second SRI field corresponds to a second SRS-ResourceSet, which corresponds with a second antenna panel of two antenna panels. Thus, each SRI may indicate an SRS resource of a corresponding SRS-ResourceSet.

While FIG. 3 corresponds with a codebook based PUSCH (or UL) transmission, however, for a noncodebook based PUSCH (or UL) transmission, a single DCI field may include two SRS resource indicator (SRI) fields such that a first SRI field corresponds to a first SRS-ResourceSet, which corresponds with a first antenna panel of two antenna panels, and a second SRI field corresponds to a second SRS-ResourceSet, which corresponds with a second antenna panel of two antenna panels. Each SRI may indicate one or more SRS resources of a corresponding SRS-ResourceSet.

As shown in a diagram 300, a first SRI field 314 and a second SRI field 316 are shown. The first SRI field 314 corresponds to a first SRS-ResourceSet 302, the second SRI field 316 corresponds to a second SRS-ResourceSet 304. The first SRS-ResourceSet 302 and/or the second SRS-ResourceSet 304 may have a respective usage set to “codebook” for codebook based simultaneous or contemporaneous PUSCH (or UL) transmission with SDM. Each SRS-ResourceSet may have two resources, for example, a first SRS-Resource 0 306 and a second SRS-Resource 1 308 for the first SRS-ResourceSet 302, and a first SRS-Resource 0 310 and a second SRS-Resource 1 312 for the second SRS-ResourceSet 304. Thus, the first SRI field 314 may be used to identify a particular SRS resource, e.g., the first SRS-Resource 306 or the second SRS-Resource 308 of the first SRS-ResourceSet 302, or the first SRS-Resource 310 or the second SRS-Resource 312 of the second SRS-ResourceSet 304. A first SRS resource in each SRS-ResourceSet may be identified using a value of 0 of an SRI field, and a second SRS resource in each SRS-ResourceSet may be identified using a value of 1 of an SRI field.

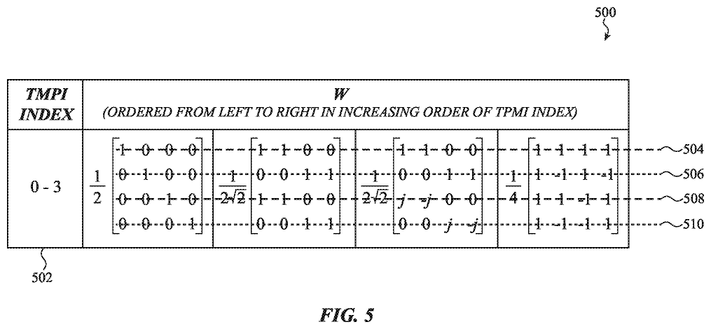

Alternatively, as shown in a diagram 400 of FIG. 4, shows another example mapping of a single SRS resource indicator field in a downlink control information (DCI) to SRS-Resources of an SRS-ResourceSet of a plurality of SRS-ResourceSets and an antenna panel of a plurality of antenna panels, according to embodiments described herein. A single SRI field may identify a pair of SRS resources, which are in the same relative location of each SRS-ResourceSet of two SRS-ResourceSets. A single SRI field may have a first value 0, shown as 414, and have a second value 1, shown as 416. The first value 0 414 may correspond to a first SRS resource in each SRS-ResourceSet, for example, a first SRS resource SRS-Resource 0 406 and a first SRS resource SRS-Resource 0 410 of a first SRS-ResourceSet 402 and a second SRS-ResourceSet 404, respectively. The second value 1 416 may correspond to a second SRS resource in each SRS-ResourceSet, for example, a second SRS resource SRS-Resource 1 408 and a second SRS resource SRS-Resource 1 412 of a first SRS-ResourceSet 402 and a second SRS-ResourceSet 404, respectively. Thus, a value of single SRI identifies an SRS resource based on their relative location in each SRS-ResourceSet.

While FIG. 4 corresponds with a codebook based PUSCH (or UL) transmission, however, for a noncodebook based PUSCH (or UL) transmission, a single DCI field may include a single SRI field identifying one or more pairs of SRS resources of each SRS-ResourceSet of two SRS-ResourceSets. A bit width of the single SRI field may be optimized corresponding to a number of layer combinations across two antenna panels. For example, the single SRI field may identify a number of SRS resources from the first SRS-ResourceSet (mapped to a first antenna panel) and the second SRS-ResourceSet (mapped to a second antenna panel). For example, [1,1] may suggest selecting 1 SRS-Resource from the first SRS-ResourceSets and 1 SRS-Resource from the second SRS-ResourceSets; [1,2] may suggest selecting 1 SRS-Resource from the first SRS-ResourceSets and 2 SRS-Resources from the second SRS-ResourceSets; [2,1] may suggest selecting 2 SRS-Resources from the first SRS-ResourceSets and 1 SRS-Resource from the second SRS-ResourceSets; and [2,2] may suggest selecting 2 SRS-Resources from the first SRS-ResourceSets and 2 SRS-Resources from the second SRS-ResourceSets.

In some embodiments, for reducing signal overhead and/or latency, for codebook based or noncodebook based simultaneous or contemporaneous PUSCH (or UL) transmission with SDM, which is scheduled using a single DCI, for reducing signal overhead and latency, transmission configuration indication (TCI) states and/or beam indications across many channels or beams may be unified. By way of a non-limiting example, a pair of unified TCI states may include two joint TCIs (for example, TCI states for UL transmission and TCI states for downlink (DL) transmission), 2 UL TCIs (for example, a first UL TCI corresponding to a first antenna panel or a first beam, and a second UL TCI corresponding to a second antenna panel or a second beam). Additionally, or alternatively, a pair of unified TCI states may include 1 joint TCI and 1 UL TCI. By way of a non-limiting example, a first TCI indicated in the unified TCI, which may also be referenced as a first unified TCI, may apply to a first SRS-ResourceSet and a second TCI indicated in the unified TCI, which may also be referenced as a second unified TCI, may apply to a second SRS-ResourceSet. The pair of unified TCI states may be communicated to a UE using a DCI. Alternatively, the pair of unified TCI states may also be communicated to a UE using a MAC control element (MAC CE).

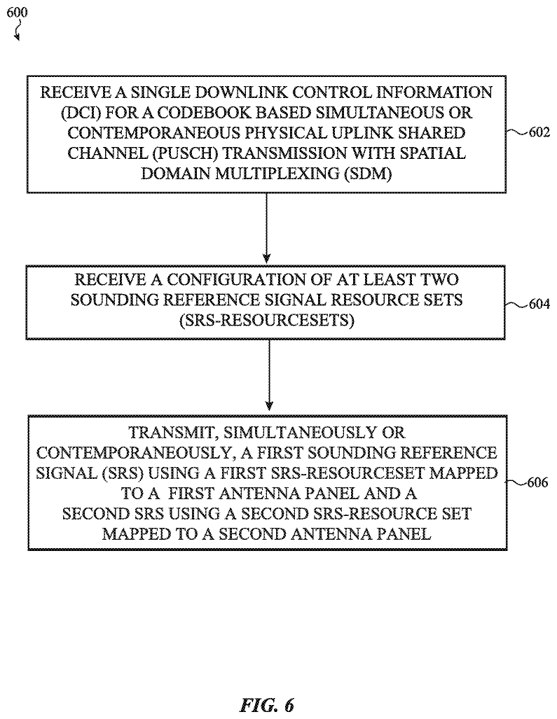

FIG. 5 shows an example mapping of transmit a precoding matrix indicator (TPMI) and a plurality of sounding reference signal (SRS) ports of a plurality of SRS-ResourceSets, according to embodiments described herein. A UE may be configured or instructed for which TPMI to be used corresponding to each SRS port of each SRS resource of each SRS-ResourceSet. In some embodiments, and by way of a non-limiting example, a single TPMI field in a DCI may apply to two SRS-ResourceSets, and accordingly each SRS port of each SRS resource of the two SRS-ResourceSets. As described herein, a first SRS-ResourceSet and a second SRS-ResourceSet may correspond with a first antenna panel and a second antenna panel, respectively. Thus, a single TPMI field included in a single DCI may describe precoding information and a number of layers of information corresponding to all SRS ports of all SRS resources of a first SRS-ResourceSet mapped to a first antenna panel and a second SRS-ResourceSet mapped to a second antenna panel, and a particular SRS resource (or an SRS-ResourceSet or an antenna panel) is indicated using a SRS Resource Set Indication field, as described herein.

A TPMI field may have a TPMI index of 0-3, which is shown in a diagram 500, as 502. A first row shown as 504 may correspond with a first SRS port of a SRS resource of a first SRS-ResourceSet mapped to a first antenna panel, and a third row shown as 508 may correspond with a second SRS port of a SRS resource of a first SRS-ResourceSet mapped to a first antenna panel. Similarly, a second row shown as 506 may correspond with a first SRS port of a SRS resource of a second SRS-ResourceSet mapped to a second antenna panel, and a fourth row shown as 510 may correspond with a second SRS port of a SRS resource of a second SRS-ResourceSet mapped to a second antenna panel. A column in the diagram 500 may correspond with a layer to which the TPMI may apply. Each antenna panel may have up to four layers. Accordingly, as shown in the diagram 500, a TPMI index 0 may indicate one layer, a TPMI index 1 may indicate two layers, a TPMI index 2 may indicate three layers, and a TPMI index 4 may indicate four layers to which the TPMI may apply.

Alternatively, two TPMI fields in a DCI may describe precoding information and a number of layers of information corresponding to two SRS-ResourceSets. Accordingly, a first TPMI field may apply to all SRS ports of an SRS resource of a first SRS-ResourceSet mapped to a first antenna panel, and a second TPMI field may apply to all SRS ports of an SRS resource of a second SRS-ResourceSet mapped to a second antenna panel.

In some embodiments, an “antenna ports” field included in a single DCI for codebook based or noncodebook based PUSCH (or UL) transmission using SDM may indicate an antenna port, which comprises one or more demodulation reference signal code division multiplexing (DMRS CDM) groups without data. Alternatively, an antenna port included in an “antenna ports” field included in a single DCI field may include two DMRS CDM groups without data. By way of a non-limiting example, DMRS ports in a first DMRS CDM group without data may be mapped to a first antenna panel, and DMRS ports in a second DMRS CDM group without data may be mapped to a second antenna panel. Further, a value 0 for DMRS-Type of 1 or 2, with maxLength of 1 or 2 and a rank of 3, may be added to also map to 2 DMRS CDM groups and 3 DMRS ports.

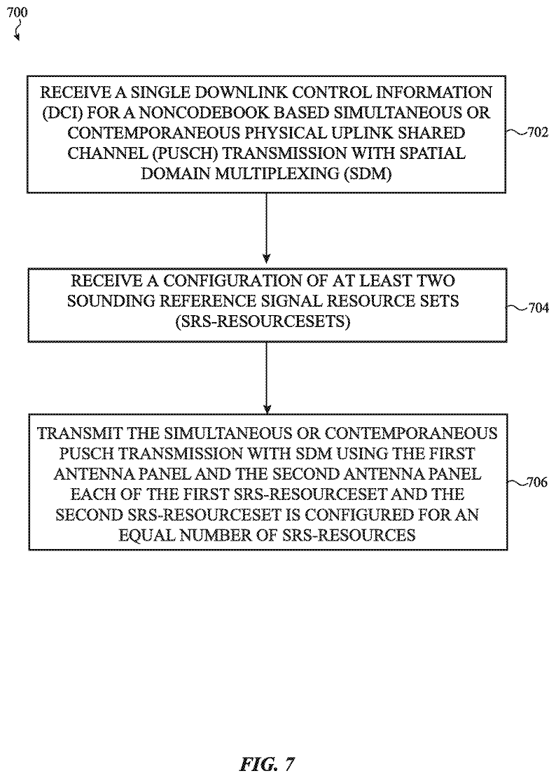

FIG. 6 shows an example method of wireless communication by a UE, which method may be used for a codebook based simultaneous or contemporaneous PUSCH transmission with SDM, according to embodiments described herein. As shown in a flow-chart 600, at 602, a UE may receive, from a network (e.g., a network device in a RAN or a CN), a single DCI for simultaneous or contemporaneous codebook based PUSCH transmission with SDM, as described herein. The single DCI schedules the PUSCH transmission with SDM, which uses a plurality of PUSCH transmissions using a plurality of antenna panels and a plurality of SRS resource sets, as described herein. The plurality of PUSCH transmissions with SDM is achieved using beam forming techniques to avoid interference as each PUSCH transmission of the plurality of PUSCH transmissions occurs simultaneously or contemporaneously using a same frequency range (or a same frequency band).

At 604, a UE may receive a configuration of at least two SRS-ResourceSets for simultaneous or contemporaneous codebook based PUSCH transmission with SDM, as described herein. A first SRS-ResourceSet of the at least two SRS-ResourceSets may be mapped to a first antenna panel of the at least two antenna panels, and a second SRS-ResourceSet of the at least two SRS-ResourceSets may be mapped to a second antenna panel of the at least two antenna panels. The configuration of the at least two SRS-ResourceSets may also include other information corresponding to one or more SRS ports of one or more SRS resources of the at least two SRS-ResourceSets, as described herein.

At 606, a UE may accordingly simultaneously or contemporaneously transmit, to the network, a first sounding reference signal (SRS) using the first SRS-ResourceSet and the first antenna panel, and transmit a second SRS using the second SRS-ResourceSet and the second antenna panel for simultaneous or contemporaneous codebook based PUSCH transmission with SDM, as described herein. Since details corresponding to various steps of the flow-chart 600 are described in detail herein, those details are not repeated again for brevity.

FIG. 7 shows an example method of wireless communication by a UE, which method may be used for noncodebook based simultaneous or contemporaneous PUSCH transmission with SDM, according to embodiments described herein. As shown in a flow-chart 700, at 702, a UE may receive, from a network (e.g., a network device in a RAN or a CN), a single DCI for simultaneous or contemporaneous noncodebook based PUSCH transmission with SDM, as described herein. The single DCI schedules the PUSCH transmission with SDM, which uses a plurality of PUSCH transmissions using a plurality of antenna panels and a plurality of SRS resource sets, as described herein. The plurality of PUSCH transmissions with SDM is achieved using beam forming techniques to avoid interference as each PUSCH transmission of the plurality of PUSCH transmissions occurs simultaneously or contemporaneously using a same frequency range (or a same frequency band).

At 704, a UE may receive a configuration of at least two SRS-ResourceSets for simultaneous or contemporaneous codebook based PUSCH transmission with SDM, as described herein. A first SRS-ResourceSet of the at least two SRS-ResourceSets may be mapped to a first antenna panel of the at least two antenna panels, and a second SRS-ResourceSet of the at least two SRS-ResourceSets may be mapped to a second antenna panel of the at least two antenna panels. The configuration of the at least two SRS-ResourceSets may also include other information corresponding to one or more SRS ports of one or more SRS resources of the at least two SRS-ResourceSets, as described herein. Each of the first SRS-ResourceSet and the second SRS-ResourceSet may be configured for an equal number of SRS-Resources.

At 706, a UE may accordingly simultaneously or contemporaneously transmit, to the network, a first sounding reference signal (SRS) using the first SRS-ResourceSet and the first antenna panel, and transmit a second SRS using the second SRS-ResourceSet and the second antenna panel for simultaneous or contemporaneous codebook based PUSCH transmission with SDM, as described herein. Since details corresponding to various steps of the flow-chart 700 are described in detail herein, those details are not repeated again for brevity.

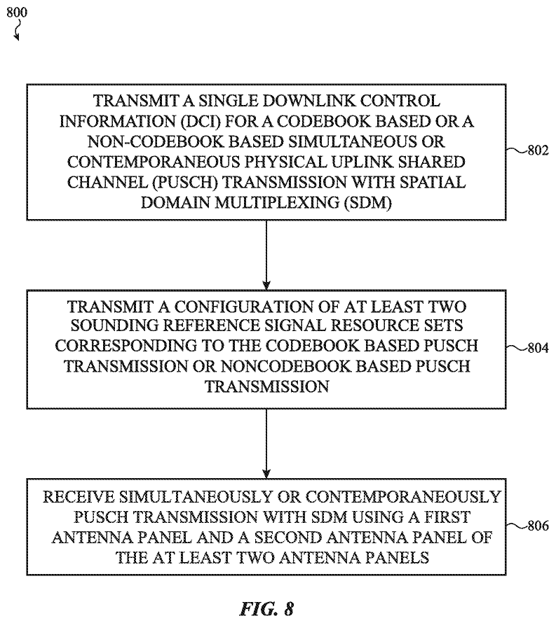

FIG. 8 shows an example method of wireless communication by a network device, which method may be used to configure a UE for codebook based or noncodebook based simultaneous or contemporaneous PUSCH transmission with SDM, according to embodiments described herein. As shown in a flow-chart 800, at 802, a network device (e.g., a network device in a RAN or a CN) may transmit, to a user equipment (UE), a single DCI for simultaneous or contemporaneous, codebook based or noncodebook based, PUSCH transmission with SDM, as described herein. The single DCI schedules the PUSCH transmission with SDM, which uses a plurality of PUSCH transmissions using a plurality of antenna panels and a plurality of SRS resource sets, as described herein. The plurality of PUSCH transmissions with SDM is achieved using beam forming techniques to avoid interference as each PUSCH transmission of the plurality of PUSCH transmissions occurs simultaneously or contemporaneously using a same frequency range (or a same frequency band).

At 804, the network device may transmit, to the UE, a configuration of at least two SRS-ResourceSets for simultaneous or contemporaneous, codebook based or noncodebook based, PUSCH transmission with SDM, as described herein. The at least two SRS=ResourceSets may have their usage set to a value corresponding to the codebook based PUSCH transmission or the noncodebook based PUSCH transmission. A first SRS-ResourceSet of the at least two SRS-ResourceSets may be mapped to a first antenna panel of the at least two antenna panels, and a second SRS-ResourceSet of the at least two SRS-ResourceSets may be mapped to a second antenna panel of the at least two antenna panels. The configuration of the at least two SRS-ResourceSets may also include other information corresponding to one or more SRS ports of one or more SRS resources of the at least two SRS-ResourceSets, as described herein.

At 806, the network device may simultaneously or contemporaneously receive from the UE a first sounding reference signal (SRS) using the first SRS-ResourceSet and the first antenna panel, and a second SRS using the second SRS-ResourceSet and the second antenna panel for simultaneous or contemporaneous codebook based PUSCH transmission with SDM, as described herein. Since details corresponding to various steps of the flow-chart 800 are described in detail herein, those details are not repeated again for brevity.

Embodiments contemplated herein include an apparatus having means to perform one or more elements of the method 600, 700, or 800. In the context of method 600 or 700, the apparatus may be, for example, an apparatus of a UE (such as a wireless device 1002 that is a UE, as described herein). In the context of method 800, the apparatus may be, for example, a network device 1020, such as a base station, as described herein).

Embodiments contemplated herein include one or more non-transitory computer-readable media storing instructions to cause an electronic device, upon execution of the instructions by one or more processors of the electronic device, to perform one or more elements of the method 600, 700, or 800. In the context of method 600 or 700, the non-transitory computer-readable media may be, for example, a memory of a UE (such as a memory 1006 of a wireless device 1002 that is a UE, as described herein). In the context of method 800, the non-transitory computer-readable media may be, for example, a memory of a network device (such as a memory 1024 of a network device 1020, as described herein).

Embodiments contemplated herein include an apparatus having logic, modules, or circuitry to perform one or more elements of the method 600, 700, or 800. In the context of method 600 or 700, the apparatus may be, for example, an apparatus of a UE (such as a wireless device 1002 that is a UE, as described herein). In the context of method 800, the apparatus may be, for example, a network device 1020, such as a base station, as described herein).

Embodiments contemplated herein include an apparatus having one or more processors and one or more computer-readable media, using or storing instructions that, when executed by the one or more processors, cause the one or more processors to perform one or more elements of the method 600, 700, or 800. In the context of method 600 or 700, the apparatus may be, for example, an apparatus of a UE (such as a wireless device 1002 that is a UE, as described herein). In the context of the method 600, the apparatus may be, for example, a network device 1020, such as a base station, as described herein).

Embodiments contemplated herein include a signal as described in or related to one or more elements of the method 600, 700, or 800.

Embodiments contemplated herein include a computer program or computer program product having instructions, wherein execution of the program by a processor causes the processor to carry out one or more elements of the method 600, 700, or 800. In the context of method 600 or 700, the processor may be a processor of a UE (such as a processor(s) 1004 of a wireless device 1002 that is a UE, as described herein), and the instructions may be, for example, located in the processor and/or on a memory of the UE (such as a memory 1006 of a wireless device 1002 that is a UE, as described herein). In the context of method 800, the processor may be a processor of a base station (such as a processor(s) 1022 of a network device 1020, as described herein), and the instructions may be, for example, located in the processor and/or on a memory of the network device (such as a memory 1024 of a network device 1020, as described herein).

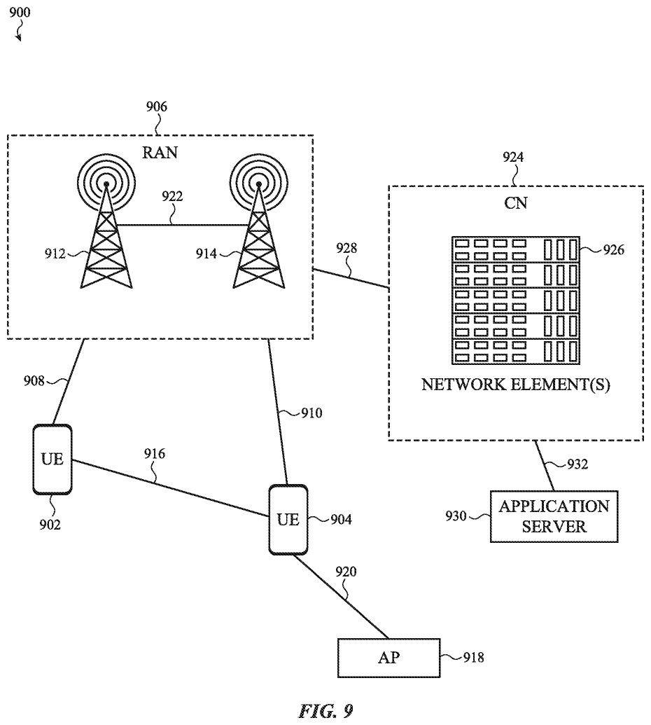

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more network devices (e.g., base stations), such as a network device 912 and a network device 914, that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the network device 912 and/or the network device 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the network device 912 or network device 914 may be implemented as one or more software entities running on server computers as part of a virtual network. In addition, or in other embodiments, the network device 912 or network device 914 may be configured to communicate with one another via interface 922. In embodiments where the wireless communication system 900 is an LTE system (e.g., when the CN 924 is an EPC), the interface 922 may be an X2 interface. The X2 interface may be defined between two or more network devices (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more network devices (e.g., two or more gNBs and the like) that connect to 5GC, between a network device 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the network device 912 or network device 914 and a serving gateway (S-GW), and the S1-MME interface, which is a signaling interface between the network device 912 or network device 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the network device 912 or network device 914 and a user plane function (UPF), and the S1 control plane (NG-C) interface, which is a signaling interface between the network device 912 or network device 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

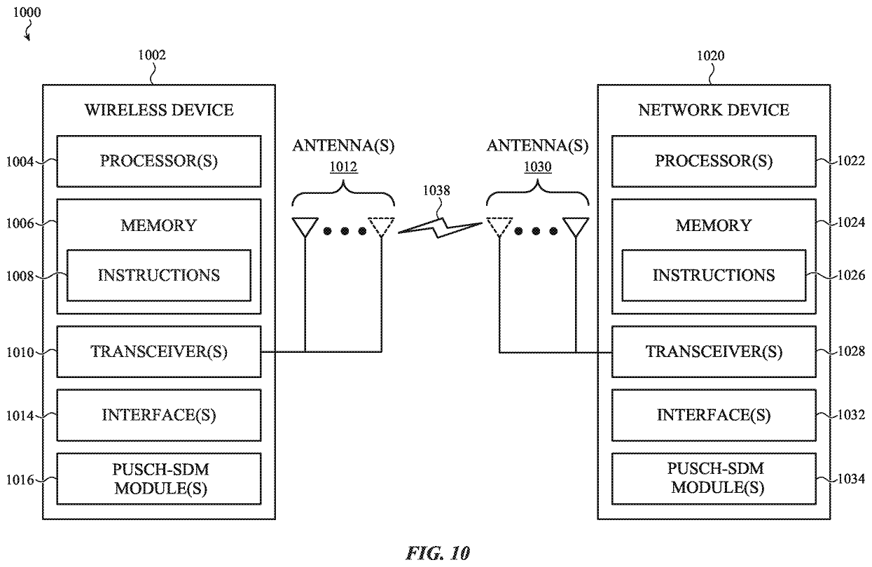

FIG. 10 illustrates a system 1000 for performing signaling 1038 between a wireless device 1002 and a network device 1020, according to embodiments disclosed herein. The system 1000 may be a portion of a wireless communication system as herein described. The wireless device 1002 may be, for example, a UE of a wireless communication system. The network device 1020 may be, for example, a network device (e.g., a base station, an eNB, or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1038) to and/or from the wireless device 1002 with other devices (e.g., the network device 1020) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include one or more modules for physical uplink shared channel transmission with SDM shown as PUSCH-SDM module(s) 1016 in FIG. 10. The PUSCH-SDM module(s) 1016 may be implemented via hardware, software, or combinations thereof. For example, the PUSCH-SDM module(s) 1016 may be implemented as a processor, circuit, and/or instructions 1008 stored in the memory 1006 and executed by the processor(s) 1004. In some examples, the PUSCH-SDM module(s) 1016 may be integrated within the processor(s) 1004 and/or the transceiver(s) 1010. For example, the PUSCH-SDM module(s) 1016 may be implemented by a combination of software components (e.g., executed by a DSP or a general processor) and hardware components (e.g., logic gates and circuitry) within the processor(s) 1004 or the transceiver(s) 1010.

The PUSCH-SDM module(s) 1016 may be used for various aspects of the present disclosure, for example, aspects of FIGS. 1-8, from a UE perspective. The PUSCH-SDM module(s) 1016 may be configured to, for example, perform PUSCH transmission with SDM (e.g., to the network device 1020).

The network device 1020 may include one or more processor(s) 1022. The processor(s) 1022 may execute instructions such that various operations of the network device 1020 are performed, as described herein. The processor(s) 1004 may include one or more baseband processors implemented using, for example, a CPU, a DSP, an ASIC, a controller, an FPGA device, another hardware device, a firmware device, or any combination thereof configured to perform the operations described herein.

The network device 1020 may include a memory 1024. The memory 1024 may be a non-transitory computer-readable storage medium that stores instructions 1026 (which may include, for example, the instructions being executed by the processor(s) 1022). The instructions 1026 may also be referred to as program code or a computer program. The memory 1024 may also store data used by, and results computed by, the processor(s) 1022.

The network device 1020 may include one or more transceiver(s) 1028 that may include RF transmitter and/or receiver circuitry that use the antenna(s) 1030 of the network device 1020 to facilitate signaling (e.g., the signaling 1038) to and/or from the network device 1020 with other devices (e.g., the wireless device 1002) according to corresponding RATs.

The network device 1020 may include one or more antenna(s) 1030 (e.g., one, two, four, or more). In embodiments having multiple antenna(s) 1030, the network device 1020 may perform MIMO, digital beamforming, analog beamforming, beam steering, etc., as has been described.

The network device 1020 may include one or more interface(s) 1032. The interface(s) 1032 may be used to provide input to or output from the network device 1020. For example, a network device 1020, which may be a network device (e.g., a base station), may include interface(s) 1032 made up of transmitters, receivers, and other circuitry (e.g., other than the transceiver(s) 1028/antenna(s) 1030 already described) that enables the network device to communicate with other equipment in a core network, and/or that enables the network device to communicate with external networks, computers, databases, and the like for purposes of operations, administration, and maintenance of the network device or other equipment operably connected thereto.

The network device 1020 may include one or more modules for physical uplink shared channel transmission with SDM shown as PUSCH-SDM module(s) 1034 in FIG. 10. The PUSCH-SDM module(s) 1034 may be implemented via hardware, software, or combinations thereof. For example, the PUSCH-SDM module(s) 1034 may be implemented as a processor, circuit, and/or instructions 1026 stored in the memory 1024 and executed by the processor(s) 1022. In some examples, the PUSCH-SDM module(s) 1034 may be integrated within the processor(s) 1022 and/or the transceiver(s) 1028. For example, the PUSCH-SDM module(s) 1034 may be implemented by a combination of software components (e.g., executed by a DSP or a general processor) and hardware components (e.g., logic gates and circuitry) within the processor(s) 1022 or the transceiver(s) 1028.

The PUSCH-SDM module(s) 1034 may be used for various aspects of the present disclosure, for example, aspects of FIGS. 1-8 from a perspective of a network device (e.g., the wireless device 1020).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, a network device (e.g., a base station), a network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

We claim:

1. A user equipment (UE), comprising:
a transceiver associated with at least two antenna panels; and
a processor configured to,
receive, from a network device and via the transceiver, a single downlink control information (DCI) for simultaneous or contemporaneous codebook based physical uplink shared channel (PUSCH) transmission with spatial domain multiplexing (SDM);
receive, from the network device and via the transceiver, a configuration of at least two sounding reference signal resource sets (SRS-ResourceSets), the at least two SRS-ResourceSets configured for use by the simultaneous or contemporaneous codebook based PUSCH transmission with SDM, a first SRS-ResourceSet of the at least two SRS-ResourceSets mapped to a first antenna panel of the at least two antenna panels, and a second SRS-ResourceSet of the at least two SRS-ResourceSets mapped to a second antenna panel of the at least two antenna panels; and
transmit to the network device and via the transceiver, simultaneously or contemporaneously, a first sounding reference signal (SRS) using the first SRS-ResourceSet and the first antenna panel, and a second SRS using the second SRS-ResourceSet and the second antenna panel, for the simultaneous or contemporaneous codebook based PUSCH transmission with SDM.

2. The UE of claim 1, wherein each of the first SRS-ResourceSet and the second SRS-ResourceSet is configured by the network device for an equal number of SRS-Resources.

3. The UE of claim 1, wherein a SRS-Resource in each SRS-ResourceSet of the at least two SRS-ResourceSets is configured with an equal number of SRS ports.

4. The UE of claim 3, wherein an uplink full power mode is 0 or 1 or not configured.

5. The UE of claim 1, wherein a SRS-Resource in each SRS-ResourceSet of the at least two SRS-ResourceSets is configured with an equal number of SRS ports when the UE is not provisioned for an uplink full power mode of 2.

6. The UE of claim 1, wherein:
the processor is further configured to facilitate a dynamic point selection (DPS) using a SRS resource set indication field of a plurality of bits in the DCI.

7. The UE of claim 6, wherein:
the plurality of bits of the SRS resource set indication field is two bits, a value of a most significant bit (MSB) of the SRS resource set indication field is set to 0, and a value of a least significant bit (LSB) of the SRS resource set indication field describes an antenna panel of the at least two antenna panels for a scheduled PUSCH transmission; or
the plurality of bits of the SRS resource set indication field is two bits, the scheduled PUSCH transmission uses two antenna panels is indicated to the network device by setting the value of the MSB of the SRS resource set indication field to 1, and the value of the LSB of the SRS resource set indication field to 0; or
the plurality of bits of the SRS resource set indication field is two bits, the value of the MSB of the SRS resource set indication field is set to 1, the value of the LSB of the SRS resource set indication field is set to 1, and the SRS resource set indication field is used to map or toggle a mapping of an antenna panel of the at least two antenna panels and a respective SRS-ResourceSet of the at least two SRS-ResourceSets.

8. The UE of claim 1, wherein the single DCI further includes information corresponding to a unified transmission configuration indicator (TCI) corresponding to each SRS resource set of the at least two SRS-ResourceSets.

9. The UE of claim 8, wherein:
the unified TCI includes a pair of unified TCI states activated or deactivated for a codebook;
the pair of unified TCI states includes two joint TCIs, two uplink TCIs, or a combination of a joint TCI and an uplink TCI;
a first unified TCI indicated in the single DCI corresponds with a first SRS resource set of the at least two SRS-ResourceSets; and
a second unified TCI indicated in the single DCI corresponds with a second SRS resource set of the at least two SRS-ResourceSets.

10. The UE of claim 1, wherein:
the single DCI further includes a single SRS resource indicator (SRI) field that describes a relative location of a SRS-Resource in the at least two SRS-ResourceSets;
the single SRI field of a value 0 corresponds with a SRS-Resource-0 of each of the at least two SRS-ResourceSets; and
the single SRI field of a value 1 corresponds with a SRS-Resource-1 of each of the at least two SRS-ResourceSets.

11. The UE of claim 1, wherein:
the single DCI further includes:
a first SRS resource indicator (SRI) field corresponding to a SRS-Resource in a first SRS-ResourceSet of the at least two SRS-ResourceSets, the first SRS-ResourceSet corresponds with a first antenna panel of the at least two antenna panels; and
a second SRI field corresponding to a SRS-Resource in a second SRS-ResourceSet of the at least two SRS-ResourceSets, the second SRS-ResourceSet corresponds with a second antenna panel of the at least two antenna panels.

12. The UE of claim 1, wherein:
the single DCI further includes:
a first transmit precoding matrix indicator (TPMI) field describing precoding information and a number of layers of information corresponding to one or more SRS ports of a SRS-Resource mapped to a first antenna panel of the at least two antenna panels; and
a second TPMI field describing the precoding information and the number of layers of information corresponding to one or more SRS ports of a SRS-Resource mapped to a second antenna panel of the at least two antenna panels.

13. The UE of claim 1, wherein:
the single DCI further includes:
a single transmit precoding matrix indicator (TPMI) field describing precoding information and a number of layers of information corresponding to all SRS ports of all SRS-Resources mapped to each antenna panel of the at least two antenna panels.

14. The UE of claim 1, wherein the single DCI further includes a single antenna port field describing an antenna port comprising one or more demodulation reference signal code division multiplexing (DMRS CDM) groups without data.

15. A user equipment (UE), comprising:
a transceiver associated with at least two antenna panels; and
a processor configured to,
receive, from a network device and via the transceiver, a single downlink control information (DCI) for simultaneous or contemporaneous noncodebook based physical uplink shared channel (PUSCH) transmission with spatial domain multiplexing (SDM);
receive, from the network device and via the transceiver, a configuration of at least two sounding reference signal resource sets (SRS-ResourceSets), the at least two SRS-ResourceSets configured for use by the simultaneous or contemporaneous noncodebook based PUSCH transmission, a first SRS-ResourceSet of the at least two SRS-ResourceSets mapped to a first antenna panel of at least two antenna panels, and a second SRS-ResourceSet of the at least two SRS-ResourceSets mapped to a second antenna panel of the at least two antenna panels; and
transmit to the network device and via the transceiver, simultaneously or contemporaneously, a first sounding reference signal (SRS) using the first SRS-ResourceSet and the first antenna panel, and a second SRS using the second SRS-ResourceSet and the second antenna panel;
each of the first SRS-ResourceSet and the second SRS-ResourceSet is configured for an equal number of SRS-Resources.

16. The UE of claim 15, wherein:
the processor is further configured to facilitate a dynamic point selection (DPS) using a SRS resource set indication field of a plurality of bits;
the plurality of bits of the SRS resource set indication field is two bits, a value of a most significant bit (MSB) of the SRS resource set indication field is set to 0, and a value of a least significant bit (LSB) of the SRS resource set indication field describes an antenna panel of the at least two antenna panels for a scheduled PUSCH transmission;
the plurality of bits of the SRS resource set indication field is two bits, the scheduled PUSCH transmission uses two antenna panels is indicated to the network device by setting the value of the MSB of the SRS resource set indication field to 1, and the value of the LSB of the SRS resource set indication field to 0; or
the plurality of bits of the SRS resource set indication field is two bits, the value of the MSB of the SRS resource set indication field is set to 1, the value of the LSB of the SRS resource set indication field is set to 1, and the SRS resource set indication field is used to map or toggle mapping of a SRI to a respective SRS-ResourceSet of the at least two SRS-ResourceSets.

17. The UE of claim 15, wherein:
the single DCI further includes information corresponding to a unified transmission configuration indicator (TCI) corresponding to each SRS resource set of the at least two SRS-ResourceSets;
the unified TCI includes a pair of unified TCI states activated or deactivated for a codebook;
the pair of unified TCI states includes two joint TCIs, two uplink TCIs, or a combination of a joint TCI and an uplink TCI;
a first unified TCI indicated in the single DCI corresponds with a first SRS resource set of the at least two SRS-ResourceSets; and
a second unified TCI indicated in the single DCI corresponds with a second SRS resource set of the at least two SRS-ResourceSets.

18. The UE of claim 15, wherein:
the single DCI further includes a single SRS resource indicator (SRI) field that describes one or more pairs of SRS-Resources from the at least two SRS-ResourceSets; or
the single DCI further includes a first SRS resource indicator (SRI) field corresponding to one or more SRS-Resources in a first SRS-ResourceSet of the at least two SRS-ResourceSets and a second SRI field corresponding to one or more SRS-Resources in a second SRS-ResourceSet of the at least two SRS-ResourceSets, the first SRS-ResourceSet corresponds with a first antenna panel of the at least two antenna panels and the second SRS-ResourceSet corresponds with a second antenna panel of the at least two antenna panels.

19. The UE of claim 15, wherein the single DCI further includes a single antenna ports field describing an antenna port comprising one or more demodulation reference signal code division multiplexing (DMRS CDM) groups without data.

20. A network device, comprising:
a transceiver; and
a processor configured to,
transmit, to a user equipment (UE) and via the transceiver, a single downlink control information (DCI) for simultaneous or contemporaneous physical uplink shared channel (PUSCH) transmission with spatial domain multiplexing (SDM), the simultaneous and contemporaneous PUSCH transmission with SDM is a codebook based PUSCH transmission or noncodebook based PUSCH transmission;
transmit, to the UE and via the transceiver, a configuration of at least two sounding reference signal resource sets (SRS-ResourceSets), the at least two SRS-ResourceSets having usage set to a value corresponding to the codebook based PUSCH transmission or the noncodebook based PUSCH transmission; and
receive, from the UE and via the transceiver, the simultaneous or contemporaneous PUSCH transmission with SDM using a first antenna panel and a second antenna panel of the at least two antenna panels.
